(19) United States
(12) Patent Application Publication
(10) Pub. No.: US 2023/0182116 A1
(43) Pub. Date: Jun. 15, 2023

(54) REGENERATING AGENT FOR RADIONUCLIDE ADSORBENT, METHOD FOR REGENERATING SPENT RADIONUCLIDE ADSORBENT USING SAME, AND METHOD FOR TREATING SPENT REGENERATING AGENT

(71) Applicant: Andong National University Industry-Academic Cooperation Foundation, Andong-si (KR)

(72) Inventors: Young-Hun KIM, Daegu (KR); Hee-Won KWON, Andong-si (KR)

(73) Assignee: Andong National University Industry-Academic Cooperation Foundation, Andong-si (KR)

(21) Appl. No.: 17/577,054

(22) Filed: Jan. 17, 2022

(30) Foreign Application Priority Data
Dec. 14, 2021 (KR) 10-2021-0178805

(51) Int. Cl. B01J 20/34; B01J 20/10

(52) U.S. Cl. CPC B01J 20/3475; B01J 20/10; B01J 20/3441; B01J 2220/42; G21F 9/12

(57) ABSTRACT

Proposed are a regenerating agent for a radionuclide adsorbent containing aqueous ammonia and organic acid, a regenerating method for a radionuclide adsorbent after using the regenerating agent for the radionuclide adsorbent, a method for treating of a spent regenerating agent obtained by the regenerating method of the spent radionuclide adsorbent, and a method of improving ion exchange capability of the regenerated radionuclide adsorbent obtained by the regenerating method of the spent radionuclide adsorbent.

### CROSS REFERENCE TO RELATED APPLICATION

The present application claims priority to Korean Patent Application No. 10-2021-0178805, filed Dec. 14, 2021, the entire contents of which is incorporated herein for all purposes by this reference.

### BACKGROUND OF THE INVENTION

### 1. Field of the Invention

The present disclosure relates to a regenerating agent for a radionuclide adsorbent, a method for regenerating a radionuclide adsorbent using the same, and a method for treating a spent regenerating agent. More particularly, the present disclosure relates to a regenerating agent for a radionuclide adsorbent containing aqueous ammonia and organic acid and a method for regenerating a spent radionuclide adsorbent using the regenerating agent for the radionuclide adsorbent. The present disclosure also relates to a method for treating a spent regenerating agent obtained by the method for regenerating a spent radionuclide adsorbent and a method of improving ion exchange capability of a regenerated radionuclide adsorbent obtained by the method for regenerating a spent radionuclide adsorbent.

### 2. Description of the Related Art

Nuclear power is an energy that replaces fossil fuels and enables low-cost, high-efficiency power generation without generating greenhouse gases. However, a large amount of radioactive material is generated during the operation, and a huge cost is required to disposal thereof.

Recently, the closure and decommissioning of some nuclear power plants in Korea have been decided, resulting in a large amount of radioactive waste, including nuclear power plant facilities and nearby contaminated soil. In order to dispose of the entire amount of radioactive waste generated at this time, a huge cost and a storage facility that must be operated for a very long time are required. Therefore, effective radioactive waste reduction technology is required to dispose of radioactive waste, and this reduction technology can have a very large economic and social effect considering the cost of installing a radioactive waste storage disposal facility and reclaiming radioactive waste.

In addition, the amount of radioactive waste generated in nuclear species leakage accidents such as Fukushima is impossible to dispose of, and measures against the mid-term to long-term damage caused by these radioactive materials are unthinkable.

Radioactive waste is generally reduced by concentrating the decontamination treated solution containing radioactive substances after dissolving the radioactive substances through decontamination treatment. A method for reducing the amount of radioactive waste liquid in which radioactive substances are dissolved by membrane separation, ion exchange resin, precipitation, or heating concentration has been proposed. However, the above method cannot separate a large amount of dissolved coexisting ions other than radioactive substances.

Korean Patent Publication No. 10-1041903 proposes a technique for selectively removing only radioactive cesium using a silicotitanate-based adsorbent. Such inorganic adsorbents are required to be used multiple times by regeneration, and high-concentration potassium (K)-based solution or ammonium (NH₄)-based solution having a similar atomic size to cesium is used as a regenerating agent.

Considering the final disposal amount, aqueous ammonia (NH₄OH) is the most ideal, but ammonium ions (NH₄⁺) form ammonia (NH₃) due to the alkalinity of the solution and thus the regeneration effect on ionic substances is very low. Therefore, a KCl solution that is not greatly affected by the acidity or an ammonium solution such as NH₄Cl and (NH₄)₂SO₄, which have the acidity are effectively used, but finally, a large amount of salt is generated, resulting in an excessive disposition amount compared to the content of the radioactive substances.

### RELATED ART LITERATURE

(Patent Document 0001) Korea Patent Publication No. 10-1041903

### SUMMARY OF THE INVENTION

An objective of the present disclosure is to provide a regenerating agent for a radionuclide adsorbent that can reduce the final disposal amount by minimizing the generation of salt by lowering the pH of aqueous ammonia.

Another objective of the present disclosure is to provide a regenerating method for a spent radionuclide adsorbent using the regenerating agent for the radionuclide adsorbent.

Another objective of the present disclosure is to provide a method for treating a spent regenerating agent obtained by the method for regenerating the spent radionuclide adsorbent.

Another objective of the present disclosure is to provide a method for improving the ion exchange capability of a regenerated radionuclide adsorbent obtained by the method for regenerating the spent radionuclide adsorbent.

In order to achieve the above objectives, the present disclosure provides a regenerating agent for a radionuclide adsorbent, including aqueous ammonia and organic acid.

According to an embodiment of the present disclosure, the normal concentration ratio of the aqueous ammonia and the organic acid may be 1:1.6 or more.

According to an embodiment of the present disclosure, the normal concentration ratio of the aqueous ammonia and the organic acid may be 1:1.6 to 1:1.83.

According to an embodiment of the present disclosure, the organic acid may be at least one selected from the group consisting of oxalic acid, acetic acid, butyric acid, palmitic acid, and tartaric acid.

According to an embodiment of the present disclosure, a pH may be adjusted to pKa=9.26 or less, which is the equilibrium point of ammonium ions and ammonia by the organic acid.

According to an embodiment of the present disclosure, the radionuclide may be at least one selected from the group consisting of cesium, strontium, and iodine.

According to an embodiment of the present disclosure, the radionuclide adsorbent may have a selective adsorption capability for radionuclides.

According to an embodiment of the present disclosure, the radionuclide adsorbent may include a silicotitanate-based adsorbent.

In order to achieve the above objectives, the present disclosure provides a regenerating method for a spent radionuclide adsorbent, and a regenerating method includes: (a) desorbing a radionuclide from the spent radionuclide adsorbent by treating the regenerating agent for the radionuclide adsorbent in a spent radionuclide adsorbent; and (b) separating the resultant product of step (a) in a solid-liquid manner to separate a regenerating agent and a spent regenerated radionuclide adsorbent.

According to an embodiment of the present disclosure, the radionuclide may be at least one selected from the group consisting of cesium, strontium, and iodine.

In order to achieve the above objective, the present disclosure provides a method for treating a spent regenerating agent, and a method for treating includes: (c) performing an advanced oxidation process for a spent regenerating agent obtained by the regenerating method for a spent radionuclide adsorbent; and (d) vacuum evaporating the residue resulting from step (c).

According to an embodiment of the present disclosure, the advanced oxidation process may oxidatively decompose organic acids using at least one selected from the group consisting of ultraviolet (UV) light, hydrogen peroxide (H₂O₂), and ozone.

According to an embodiment of the present disclosure, the organic acid may be at least one selected from the group consisting of oxalic acid, acetic acid, butyric acid, palmitic acid, and tartaric acid.

According to an embodiment of the present disclosure, ammonia and moisture may be removed by vacuum evaporation.

According to an embodiment of the present disclosure, the method may further include disposing of radionuclide waste remaining after step (d).

In order to achieve the above objective, the present disclosure provides a method for improving the ion exchange capability of a regenerated radionuclide adsorbent. The method includes converting ammonium ions substituted in the regenerated radionuclide adsorbent into hydrogen ions by heat-treating a regenerated radionuclide adsorbent separated by the regenerating method for a spent radionuclide adsorbent.

According to the present disclosure, the following effects can be expected.

By excluding the salt generated from a regenerating agent, the amount of radioactive waste generated can be greatly reduced. Considering the cost of installing a waste disposal facility and landfill, the method, according to the present disclosure, can greatly reduce economic and social costs.

In addition, this method can actively regenerate selective adsorbents. Through the expansion and distribution of the technology, it is possible to actively separate radioactive substances and coexisting ions in the waste liquid and reduce the amount of waste disposal.

In addition, when a radioactive substance is recovered and concentrated using a highly selective adsorbent, a regenerated radionuclide adsorbent may be expected to be reused as a raw material for radiation in fields such as medical care.

In addition, this technology can be effectively used for the treatment of decontamination waste liquid generated during the nuclear power plant dismantling project and can be used as a cleaning technology for the soil of the nuclear power plant site. In addition, technology export is possible in accordance with the global policy to phase out nuclear power.

In addition, this technology can be effectively used to restore radioactive soil contamination and can be used as a response technology for similar situations such as nuclear accidents.

### BRIEF DESCRIPTION OF THE DRAWINGS

FIG. 1 shows results of measuring the pH according to aqueous ammonia and oxalic acid concentration ratio of a regenerating agent for a radionuclide adsorbent prepared according to an embodiment of the present disclosure;

FIG. 2 shows a regeneration rate of an adsorbent of aqueous ammonia and oxalic acid mixture contained in a regenerating agent of a radionuclide adsorbent according to an embodiment of the present disclosure;

FIG. 3 shows results of measuring a weight of an evaporation residue at a condition of 105° C. after UV and H₂O₂ treatment of the spent regenerating agent of the present disclosure; and

FIG. 4 shows an overall process diagram of a regenerating method of a spent radionuclide adsorbent of the present disclosure and a method for treating a spent regenerating agent obtained by the regenerating method of the spent radionuclide adsorbent.

### DESCRIPTION OF THE PREFERRED EMBODIMENTS

A first embodiment of the present disclosure relates to a regenerating agent for a radionuclide adsorbent, including aqueous ammonia and organic acid.

Preferably, a regenerating agent for the radionuclide adsorbent may consist of the mixture of aqueous ammonia and organic acid but is not limited thereto. However, the regenerating agent for the radionuclide adsorbent of the present disclosure may provide an ammonium concentration of up to 0.385 N but is not limited thereto.

In order to use aqueous ammonia as a regenerating agent, it is necessary to adjust a pH of a solution in which ammonium ions are the dominant species. The equilibrium point of ammonia and ammonium ions is pKa=9.26. Ammonium ions become dominant species at a pH lower than that pKa value, and most of the solutions are present in the form of ammonium at pH=7 or less.

When a general strong acid (HCl, HNO₃, H₂SO₄, etc.) is used to lower the pH of the regenerating agent, a salt is finally generated by chlorine, nitric acid, sulfuric acid ions, etc., injected together with the acid, which generates the same amount of salt as the existing ammonium solution, and thus has no effect in reducing the final disposal amount.

In the regenerating agent of the radionuclide adsorbent, the normal concentration ratio of aqueous ammonia and organic acid may be 1:1.6 or more, preferably 1:1.6 to 1:1.83, but is not limited thereto.

The organic acid contained in the regenerating agent of the radionuclide adsorbent is an acidic organic compound and has low dissociation properties compared to inorganic acids but can provide sufficient hydrogen ions (H⁺) lower the pH of aqueous ammonia. Constituent elements of the organic acid are carbon, oxygen, and hydrogen and are decomposed into CO₂ and H₂O by oxidation treatment, and salt is not generated when complete oxidation decomposition is performed.

The organic acid may be at least one selected from the group consisting of oxalic acid, acetic acid, butyric acid, palmitic acid, and tartaric acid, but is not limited thereto. A pH of the aqueous ammonia may be adjusted by the organic acid to pKa=9.26 or less, which is the equilibrium point between ammonium ions and ammonia but is not limited thereto.

In the first embodiment, the radionuclide may be at least one selected from the group consisting of cesium (Cs), strontium (Sr), and iodine (I), preferably cesium or strontium, more preferably cesium, but is not limited thereto.

The radionuclide adsorbent may be used without limitation as long as it has the ability to adsorb radionuclides selectively, for example, a silicotitanate-based adsorbent but is not limited thereto.

A second embodiment of the present disclosure relates to a regenerating method for a spent radionuclide adsorbent, and the method includes: (a) desorbing a radionuclide from the spent radionuclide adsorbent by treating the regenerating agent of the radionuclide adsorbent in a spent radionuclide adsorbent; and (b) separating the resultant product of step (a) in a solid-liquid manner to separate a spent regenerating agent and a regenerated radionuclide adsorbent.

In the second embodiment, the radionuclide may be at least one selected from the group consisting of cesium (Cs), strontium (Sr), and iodine (I), preferably cesium or strontium, more preferably cesium, but is not limited thereto.

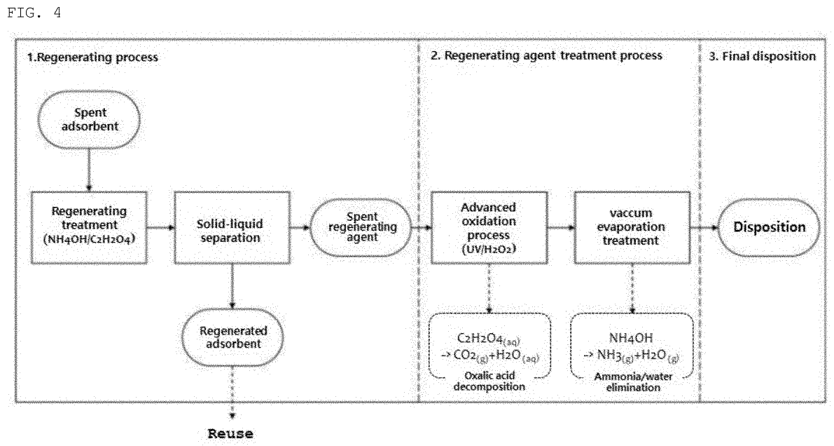

The regenerating method for the spent radionuclide adsorbent according to the second embodiment of the present disclosure will be more clearly understood with reference to the regeneration process of FIG. 4, and thus a detailed description thereof will be omitted.

A third embodiment of the present disclosure relates to a method for treating a spent regenerating agent, and the method includes: (c) performing an advanced oxidation process for a spent regenerating agent obtained by the regenerating method for the spent radionuclide adsorbent; and (d) vacuum evaporating the residue resulting from step (c).

The advanced oxidation process completely oxidizes and decomposes the organic acid in a short time using at least one selected from the group consisting of ultraviolet (UV) light, hydrogen peroxide (H₂O₂), and ozone, preferably UV/H₂O₂ or ozone. Thus, the advanced oxidation process is possible to induce a complete oxidation reaction in which no oxidizing agent by-products are generated.

The organic acid may be at least one selected from the group consisting of oxalic acid, acetic acid, butyric acid, palmitic acid, and tartaric acid, but is not limited thereto.

After the advanced oxidation process, the spent regenerating agent remaining may remove ammonia and moisture therein using a conventional reduction technology, preferably vacuum evaporation, but is not limited thereto.

The method for treating the spent regenerating agent of the present disclosure may further include disposing of the radionuclide waste remaining after step (d), wherein the radionuclide waste may be a reduced amount radionuclide waste in which salt is not generated.

The method for treating the spent regenerating agent according to the third embodiment of the present disclosure will be more clearly understood with reference to the regenerating agent treatment process of FIG. 4, and thus a detailed description thereof will be omitted.

A fourth embodiment of the present disclosure relates to a method of improving an ion exchange capability of a regenerated radionuclide adsorbent, and the method includes a step of converting ammonium ions substituted in the regenerated radionuclide adsorbent into hydrogen ions by heat-treating a regenerated radionuclide adsorbent separated by the method of regenerating the spent radionuclide adsorbent.

In the fourth embodiment, the radionuclide may be at least one selected from the group consisting of cesium (Cs), strontium (Sr), and iodine (I), preferably cesium or strontium, more preferably cesium, but is not limited thereto.

The heat treatment may be performed, for example, at 100° C. to 500° C., preferably at 200° C. to 400° C. for 3 to 12 hours, preferably for 3 to 5 hours, but is not limited thereto. The ammonium ions are converted into hydrogen ions by the heat treatment because the ammonium ions are decomposed into hydrogen ions and ammonia gas by heat, and the ammonia gas is released in the molecular sieve.

Hereinafter, the present disclosure will be described in more detail through examples. However, the following examples are intended to illustrate the present disclosure, and the scope of the present disclosure is not limited thereto.

### <Example 1> Preparation of Regenerating Agent (1)

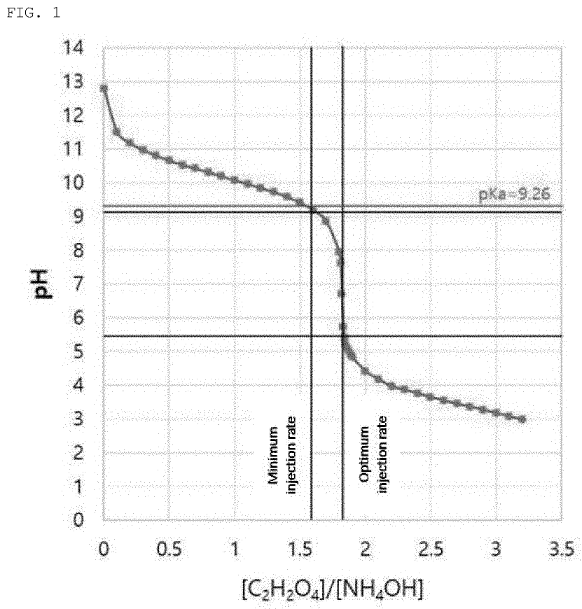

After adding aqueous ammonia and oxalic acid, the mixture was stirred and mixed at room temperature for 5 minutes to prepare a regenerating agent for a spent adsorbent, and the results of measuring the pH according to the concentration ratio of aqueous ammonia and oxalic acid are shown in FIG. 1.

As shown in FIG. 1, it can be seen that the pH value in which ammonium ion is the dominant species is pKa=9.26, the minimum injection ratio of ammonia and oxalic acid based on the normal concentration is 1:1.6, and the optimal injection ratio is 1:1.83. At this time, the respective ammonia concentrations were 0.385 N and 0.353 N.

### <Example 2> Preparation of Regenerating Agent (2)

After adding aqueous ammonia and acetic acid, the mixture was stirred at room temperature for 5 minutes and mixed to prepare a regenerating agent for the spent adsorbent.

### <Example 3> Preparation of Regenerating Agent (3)

After adding aqueous ammonia and butyric acid, the mixture was stirred at room temperature for 5 minutes and mixed to prepare a regenerating agent for the spent adsorbent.

### <Example 4> Preparation of Regenerating Agent (4)

After adding aqueous ammonia and palmitic acid, the mixture was stirred at room temperature for 5 minutes and mixed to prepare a regenerating agent for the spent adsorbent.

### <Example 5> Preparation of Regenerating Agent (5)

After adding aqueous ammonia and tartaric acid, the mixture was stirred at room temperature for 5 minutes and mixed to prepare a regenerating agent for the spent adsorbent.

### <Example 6> Regeneration of Cesium Adsorbent by Regenerating Agent

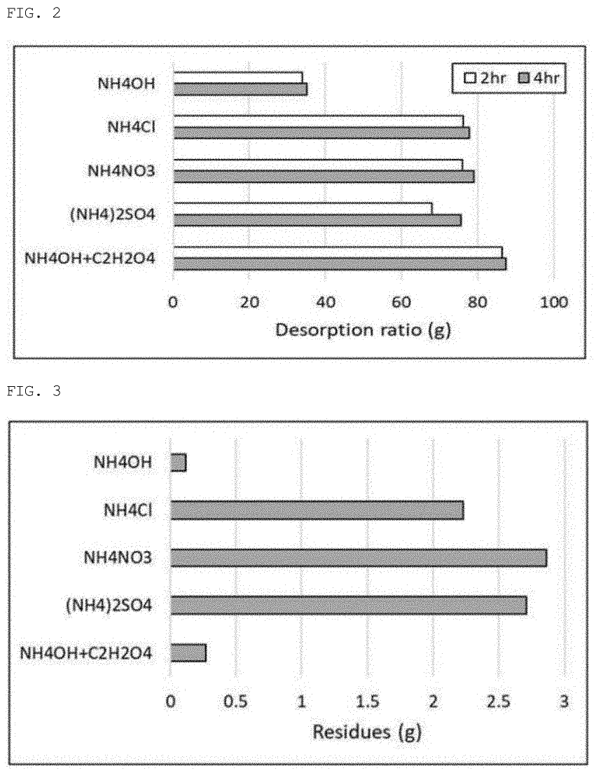

The results of measuring the regeneration rate of a cesium adsorbent using the regenerating agent of the spent adsorbent prepared in Example 1 are shown in FIG. 2.

At this time, the regeneration rate was analyzed by measuring the desorbed and eluted cesium ions by controlling the same concentrations of aqueous ammonia, ammonium chloride, ammonium nitrate, and ammonium sulfate. All experiments were conducted under the same conditions.

In addition, an adsorbent artificially contaminated with cesium was used. For a regeneration reaction, 100 ml of each regeneration solution was added to 1.0 g of the artificially contaminated adsorbent. Then a reaction was induced for 2 to 4 hours at 200 rpm using an orbital shaker. All experiments were conducted at room temperature.

As shown in FIG. 2, it can be seen that the cesium adsorption efficiency of the regenerating agent, including a mixture of aqueous ammonia and organic acid (oxalic acid) of Example 1, is the best.

### <Example 7> Treatment of Spent Regenerating Agent

After the advanced oxidation process using UV and H₂O₂ to the spent regenerating agent in Example 6, the spent regenerating agent remaining after the process was evaporated at a temperature of 105° C. using an electric oven, and the weight of the residue was measured. The measurement results are shown in FIG. 3.

As shown in FIG. 3, it can be seen that, with the exception of aqueous ammonia (NH₄OH), the weight of the residue is remarkably low when a regenerating agent consisting of the mixture of aqueous ammonia and organic acid (oxalic acid) is used.

On the other hand, in the case of the aqueous ammonia, there is a problem that the ammonium ion (NH₄) is in the form of ammonia (NH₃) due to the alkalinity of the solution, so that the regeneration effect on the ionic material is very low.

### <Example 8> Heat Treatment of Regenerated Cesium Adsorbent

Cesium was desorbed from the cesium adsorbent using the regenerating agent of the spent adsorbent prepared in Example 1, and then a regenerated cesium adsorbent obtained by the solid-liquid manner with centrifugal separation at 1,000 rpm for 5 minutes was heat-treated at 300° C. for 4 hours to obtain a regenerated cesium adsorbent with improved ion exchange capability.

As described above in detail, a specific part of the content of the present disclosure, for those of ordinary skilled in the art, this specific description is only a preferred embodiment, and the scope of the present disclosure is not limited thereby.

Accordingly, it is intended that the appended claims and their equivalents define the substantial scope of the present disclosure. Simple modifications or changes of the present disclosure can be easily used by those of ordinary skilled in the art, and all such modifications or changes can be considered to be included in the scope of the present disclosure.

What is claimed is:

1. A regenerating agent for a radionuclide adsorbent, the regenerating agent comprising aqueous ammonia and organic acid.

2. The regenerating agent of claim 1, wherein a normal concentration ratio of the aqueous ammonia and the organic acid is 1:1.6 or more.

3. The regenerating agent of claim 1, wherein the normal concentration ratio of the aqueous ammonia and the organic acid is 1:1.6 to 1:1.83.

4. The regenerating agent of claim 1, wherein the organic acid is at least one selected from the group consisting of oxalic acid, acetic acid, butyric acid, palmitic acid, and tartaric acid.

5. The regenerating agent of claim 1, wherein a pH is adjusted by the organic acid to pKa=9.26 or less, which is an equilibrium point of ammonium ions and ammonia.

6. The regenerating agent of claim 1, wherein the radionuclide is at least one selected from the group consisting of cesium, strontium, and iodine.

7. The regenerating agent of claim 1, wherein the radionuclide adsorbent has an ability to selectively adsorb radionuclides.

8. The regenerating agent of claim 7, wherein the radionuclide adsorbent comprises a silicotitanate-based adsorbent.

9. A method for regenerating a spent radionuclide adsorbent, the method comprising:
(a) desorbing a radionuclide from a spent radionuclide adsorbent by treating the spend radionuclide adsorbent with the regenerating agent of claim 1; and
(b) performing a solid-liquid separation process on the resultant product of step (a) to separate a spent regenerating agent and a regenerated radionuclide adsorbent from each other.

10. The method of claim 9, wherein the radionuclide is at least one selected from the group consisting of cesium, strontium, and iodine.

11. A method for treating a spent regenerating agent, the method comprising:
(c) performing an advanced oxidization process on the spent regenerating agent obtained by the method of claim 9; and
(d) vacuum evaporating the residue resulting from step (c).

12. The method of claim 11, wherein the advanced oxidation process comprises oxidatively decomposing organic acid using at least one selected from the group consisting of ultraviolet (UV) light, hydrogen peroxide (H₂O₂), and ozone.

13. The method of claim 12, wherein the organic acid is at least one selected from the group consisting of oxalic acid, acetic acid, butyric acid, palmitic acid, and tartaric acid.

14. The method of claim 11, wherein ammonia and moisture are removed by the vacuum evaporation.

15. The method of claim 11, wherein the method further comprises disposing of radionuclide waste remaining after step (d).

16. A method of improving ion exchange capability for a regenerated radionuclide adsorbent, the method comprising a step of converting ammonium ions substituted in the regenerated radionuclide adsorbent into hydrogen ions by heat-treating the regenerated radionuclide adsorbent separated by the method of claim 9.
